(19) United States
(12) Patent Application Publication
(10) Pub. No.: US 2006/0127558 A1
(43) Pub. Date: Jun. 15, 2006

(54) Germinated beans with excellent flavor, processed food therewith, and foods containing the same

(75) Inventors: Akira Nagatoishi, Kanagawa (JP); Haruna Aida, Kanagawa (JP); Youji Harada, Kanagawa (JP)

Correspondence Address: JACKIE JAY SCHWARTZ, 1350 Broadway, Suite 1510, NEW YORK, NY, 10018, US

(73) Assignee: The Nisshin OilliO Group, Ltd.

(21) Appl. No.: 11/327,082

(22) Filed: Jan. 6, 2006

Related U.S. Application Data
(63) Continuation of application No. PCT/JP04/10062, filed on Jul. 8, 2004.

(30) Foreign Application Priority Data
Jul. 11, 2003 (JP) JP2003-196161

(51) Int. Cl. A23L 1/20

(52) U.S. Cl. 426/634

(57) ABSTRACT

With the use of germinated beans having a germination ratio of 10 to 100%, the mass ratio of gamma-aminobutyric acid content and isoflavone content is held in a predetermined range, and in some cases, the content of gamma-aminobutyric acid per 100 g of solid content of beans is held in a predetermined range. Furthermore, with the use of germinated beans as a main ingredient of a bean processed food, the nutritive value of the bean processed food is enhanced and also improves the taste.

### TECHNICAL FIELD

The present invention relates to germinated beans having excellent flavor and high nutritive value and to processed foods using the same as a main ingredient, and foods containing the same. In particular, the present invention relates to a germinated bean having excellent flavor and high nutritive value in which the mass ratio of gamma-aminobutyric acid to isoflavone and content of gamma-aminobutyric acid in the beans are maintained at particular values, and also relates to processed foods using such beans and foods using such processed foods.

### BACKGROUND ART

The term “beans” is generally used torefer to leguminous plants. Leguminous plants are widely distributed all over the world from the temperate zones to the tropics. Legumes are classified into as many as 600 groups with 12,000 species worldwide. The species include herbs, shrubs, trees and even vines. Bean seeds of such types as soybeans, kidney beans, adzuki beans, peanuts, broad beans, and peas are used. The cotyledons of these plants have been used from long ago as food because of their high nutrition value in carbohydrates, protein, fat, etc.

Germinated vegetables (sprouts) as represented by germinated brown rice are widely known recently as containing large quantities of compounds which are excellent for health, and thereby gaining attention, particularly from those who focus on their health, and are becoming a new trend as a healthy food. Among these, the most popular germinated vegetable is a germinated brown rice. Germination increases gamma-aminobutyric acid, and the saccharogenic amylase contained therein works to yield sweetness to a higher degree. Reference: Jun Ooumi (April 2001) “All about Germinated Brown Rice” by the Japan Research Institute of Labor, pp. 119-127, pp. 161-165.

The gamma-aminobutyric acid, a type of amino acid widely distributed in animals and plants, exists in the encephalons of animals where it stimulates blood flow in the brain as a principal inhibitory neurotransmitter, increases oxygen supply to the brain, promotes metabolism in the brain cells, achieves symptomatic improvement in the case of headaches observed as an aftereffect of, for example, cerebral stroke, or lowers the blood pressure by acting upon the vasomotor center in the bulbar. Additionally, isoflavone is a flavonoid contained mainly in soybeans and acts like a female hormone, and their preventive effects on osteoporosis, menopause, etc., have often been reported.

These nutrient compositions, on the other hand, also have an influence upon the flavor of beans. The gamma-aminobutyric acid is a type of amino acid involved in taste, and according to the volume the contents have an influence upon the balance of the overall taste while it relates to the taste from other amino acids. In addition, isoflavone has bitterness, and it is not a preferred ingredient at a point of a flavor. No study on improvement of taste that is deteriorated by bitterness of isoflavone has, however, been conducted until recently.

Soybeans, known for their excellent nutritional content which is similar to meat but is grown in the field, are particularly richer in protein than other beans, and it also yields a large quantity of soybean oil that contains essential fatty acids. Furthermore, it has been scientifically demonstrated that soybean protein lowers the risk of heart disease and reduces cholesterol. Also, soybean isoflavone, as one of its nutrients, has been studied recently for its protective effects against osteoporosis. Soybean-processed foods containing soybeans as its main ingredient have been observed in the Japanese diet for a long time as a traditional food. This includes fermented soybean paste, fermented soybeans, bean curd, and soybean milk. Soybean milk was consumed in large amounts in the 1980s when it was very popular; however, the quantity of consumption has dropped due to its peculiar odor and bitter taste. Recent expansion of the soybean milk market is seen to be due not only to people's strong interest in diet and health, but also due to the threat of mad cow disease.

In order to obtain soybean milk that is rich in vitamin C and has greater digestibility, production of soybean milk utilizing sprouted soybeans has been developed. Additionally, production under specified conditions of soybean processed foods that contain germinated soybeans as a main ingredient has been developed in order to improve the taste by increasing glutamic acid or saccharose.

Patent Documents:

Japanese Laid-Open Patent Application Publication No. S-59-17947

Japanese Laid-Open Patent Application Publication No. H-11-123060

Consumers can now obtain a variety of information on nutrients and thus have greater expectation about the nutrients. Their appetite for taste seems never to stop, and they more strongly pursue better taste. For this reason, the foods of which nutrients and taste have been improved in a conventional manner should attain further improvement to satisfy consumer's needs. With this in mind, we have targeted a bean with greater nutrients and taste from a viewpoint other than mere vitamin C, glutamic acid, or saccharose content.

Japanese Laid-Open Patent Application Publication No. H-11-123060 discloses use of germinated beans that have no shoots or roots growing out of the bean's skin as a main ingredient in order to improve the taste. Such beans, however, show no improvement in terms of bitterness or astringency. The present invention pursues greater nutrients and taste by conducting germination in such a way that the ratio of germination is kept within a predetermined range.

Japanese Laid-Open Patent Application Publication No. H-11-151072 discloses a method for increasing the content of gamma-aminobutyric acid in the soybean, and Japanese Laid-Open Patent Publication No. 2002-45138 discloses a bean curd with content of no less than 10 mg of gamma-aminobutyric acid; however, both of the above merely increased contents of gamma-aminobutyric acid and increased the taste, but failed to improve the overall taste. Neither of the above discussed the improvement of the taste of soybeans by adjusting the content of gamma-aminobutyric acid and isoflavone, an astringency component.

The present invention is provided to solve the aforementioned drawbacks in the conventional technology. An object of the present invention is to pursue greater nutrients and better taste of beans by maintaining a mass ratio of the content of gamma-aminobutyric acid and isoflavone in a constant range, and in some cases the content of gamma-aminobutyric acid in the bean is also held within a constant range.

Another object of the present invention is to provide a soybean processed food with greater nutrient and better taste by using, as a main ingredient in soybean processed foods, beans in which the mass ratio of the content of gamma-aminobutyric acid and isoflavone is held within a constant range, and in some cases, the content of gamma-aminobutyric acid in the bean is also held within a constant range.

### DISCLOSURE OF THE INVENTION

The inventors of the present invention have diligently researched germination of beans, and as a result, have found beans with greater nutrient composition and better taste by conducting germination. The germination of the present invention is held within a constant range so that the content of isoflavone which is contained in the beans as an astringency component, and the content of gamma-aminobutyric acid which is an amino acid taste component, can be controlled to balance within a constant range, and additionally the content of gamma-aminobutyric acid is held within a constant range.

Moreover, the present invention provides a group of germinated beans which have a germination ratio of 10 to 100% and have 10/100 to 250/100 of mass ratio of gamma-aminobutyric acid to isoflavone, and in that 70 to 100% have beans with the shoots or roots extending to a length of 0.5 to 20 mm. Furthermore, the present invention provides a group of germinated beans that have 10 to 100% germination ratio and have 10/100 to 250/100 of mass ratio of gamma-aminobutyric acid to isoflavone, and the content of gamma-aminobutyric acid per 100 g of the solid content is 50 to 500 mg. Furthermore, the present invention provides a group of germinated beans that have 10 to 100% germination ratio and have 10/100 to 250/100 of mass ratio of gamma-aminobutyric acid to isoflavone, in that 70 to 100% have beans with the shoots or roots extending to a length of 0.5 to 20 mm, and the content of gamma-aminobutyric acid per 100 g of the solid content is 50 to 500 mg. The present invention provides one or more types of germinated beans selected from soybeans, green soybeans, kidney beans, adzuki beans, peanuts, broad beans, peas, and/or black beans. The present invention further provides foods that use group of germinated beans.

The present invention provides a bean processed food having as a main ingredient a group of germinated beans that have 10 to 100% germination ratio and have 10/100 to 250/100 of mass ratio of gamma-aminobutyric acid to isoflavone. Moreover, the present invention provides a bean processed food having as a main ingredient a group of germinated beans that have 10 to 100% germination ratio and have 10/100 to 250/100 of mass ratio of gamma-aminobutyric acid to isoflavone, in that 70 to 100% have beans with the shoots or roots extending to a length of 0.5 to 20 mm. Furthermore, the present invention provides a bean processed food having as a main ingredient a group of germinated beans that have 10 to 100% germination ratio and have 10/100 to 250/100 of mass ratio of gamma-aminobutyric acid to isoflavone, and the content of gamma-aminobutyric acid per 100 g of the solid content is 50 to 500 mg. Furthermore, the present invention provides a bean processed food having as a main ingredient a group of germinated beans that have 10 to 100% germination ratio and have 10/100 to 250/100 of mass ratio of gamma-aminobutyric acid to isoflavone, in that 70 to 100% have beans with shoots or roots extending to a length of 0.5 to 20 mm, and the content of gamma-aminobutyric acid per 100 g of the solid content is 50 to 500 mg. The present invention provides a bean processed food having as a main ingredient a group of one or more types of germinated beans selected from soybeans, green soybeans, kidney beans, adzuki beans, peanuts, broad beans, peas, and/or black beans. The present invention further provides foods that use the bean processed food.

The present invention provides a bean processed food that have 10/100 to 250/100 of mass ratio of gamma-aminobutyric acid to isoflavone having as a main ingredient a group of germinated beans described above. Furthermore, the present invention provides a bean processed food that have 10 to 100% germination ratio and have 10/100 to 250/100 of mass ratio of gamma-aminobutyric acid to isoflavone, and the content of gamma-aminobutyric acid per 100 g of the solid content is 50 to 500 mg having as a main ingredient a group of germinated beans described above. The present invention provides a type of bean processed food selected from soybean milk, bean curd, soybean curd pulp, fermented soybean paste, or fermented soybean. The present invention also provides foods that use the soybean processed food.

The present invention provides a manufacturing method of germinated beans including processes of: immersing beans in water at 10 to 45 degrees Celsius or hotter water for 0.5 to 36 hours; and contacting with air or oxygen for 19 to 36 hours during or after the immersion. In this case, it is preferable that the air-contacting process be conducted during the immersing process, in which the air-contacting process is a process that blows air or oxygen into the water or hot water. It is also preferable that the air-contacting process be conducted after the immersing process, in which the air-contacting process further conducts immersion of beans into water or hot water, or water or hot water is sprinkled thereon at predetermined intervals. It is further preferable that the beans be germinated in such a way that the ratio of the beans with shoots or roots germinated to a length of 0.5 to 20 mm constitutes 70 to 100% of all the beans that have been subjected to the germination process and actually germinated. As for the beans used herein, one or more types of beans are preferably selected from soybeans, green soybeans, kidney beans, adzuki beans, peanuts, broad beans, peas, and black beans.

According to the present invention, germinated beans with good taste can be obtained by maintaining the content balance of gamma-aminobutyric acid and isoflavone in a constant range, and by maintaining the content of gamma-aminobutyric acid per 100 g of solid beans within a constant range. The present invention can further provide foods that use germinated beans or bean processed food with good taste.

### PREFERRED MODE FOR CARRYING OUT THE INVENTION

The germinated bean according to the present invention is described hereinafter. The type of germinated bean of the present invention is not limited and includes soybeans, green soybeans, kidney beans, adzuki beans, peanuts, broad beans, peas, black beans, etc. Among these, soybean is most preferable in terms of its nutritive value, processing suitability, and availability. The soybeans may be any soybeans such as those grown in Japan, soybeans grown in the U.S. like IOM, genetically modified soybeans, or non-genetically modified soybeans.

The ratio of germination of beans used in the present invention is preferably 10 to 100%, more preferably 20 to 100%, and most preferably 30 to 95%. When the ratio is 10% or less, the content of gamma-aminobutyric acid per 100 g of solid beans becomes 50 mg or less, and the mass ratio of gamma-aminobutyric acid to isoflavone in the beans cannot be maintained within a range of 10/100 to 250/100, thus causing strong astringency and bitterness.

The ratio of germination used in the present invention means a ratio of the number of beans actually germinated among one hundred beans, and calculated by the equation:
Ratio of germination in %=Number of germinated beans (Number)/100(Number)×100=Number of germinated beans

Germination in general use includes a state in which shoots, pollen, seeds or spores of plants start growing (Second edition of Daijirin, Sanseido), or the growth of each organ in an embryo that has differentiated in the seed (Yoshio Masuda, Shokubutsu Senrigaku, fourteenth revision, October 2001, pp. 51-57). However, the term “germination” used in the present invention refers to a state in which a shoot or root of a bean breaks out of the bean skin, and the number of germinated beans used in the equation refers to a number of beans actually germinated among one hundred beans selected arbitrarily from beans under a germination process.

The method of germination for obtaining germinated beans of the present invention is not limited, but may include methods including an immersing process in which beans are immersed into water or hot water of, for example, at 10 to 45 degrees Celsius, preferably 20 to 45 degrees Celsius, or more preferably 30 to 42 degrees Celsius, for preferably 1 to 10 hours, or more preferably 1 to 5 hours, and an air-contacting process in which beans are exposed to air or oxygen for 19 to 36 hours, preferably for 20 to 30 hours, and more preferably for 20 to 24 hours, during or after the immersion process.

In some cases in the immersion process, germination is not conducted easily when the processing temperature is 10 degrees Celsius or lower, or in other cases the ratio of germination drops when the processing temperature is 45 degrees Celsius or higher. In terms of immersion time, beans may not germinate easily when immersed in water or hot water for 0.5 hours or less; however, if the immersion time exceeds 36 hours, the beans may not germinate easily due to excessive water absorption, or putrefaction or even elution of nutrient composition may result.

Alternatively, the beans may not germinate easily when either the air-contacting time is 19 hours or less. In other cases, the shoots or roots may grow excessively when the air-contacting time exceeds 36 hours, causing degradation of taste due to loss of flavor and sweetness.

In the case in which the air-contacting process is conducted after the immersion process, the air-contacting process may include spraying of water or hot water as appropriate so that the surface of beans do not dry out, or may include immersion of beans into water or hot water for a short period of time. In this case, the spraying or immersion is conducted preferably with an interval of 2 hours to 12 hours, and more preferably with an interval of 2 hours to 7 hours. Each round of spraying or immersion is conducted, preferably for 1 to 30 minutes, and more preferably for 3 to 15 minutes.

It is also preferable that air or oxygen be blown into water or hot water when conducting the air-conducting process during the immersion process so that germination is promoted. This method promotes germination without exposing beans to air or oxygen after the immersion process as described above. In this case, the blowing volume of air or oxygen to a weight of 100 g of beans before the immersion process is preferably 50 ml/min to 3000 ml/min. The blowing may be conducted either consecutively or intermittently.

The gamma-aminobutyric acid of the present invention is a type of amino acid involved in taste that is widely distributed in animals and plants. In animals, the gamma-aminobutyric acid exists in the encephalon and works as a major inhibitory neurotransmitter. The gamma-aminobutyric acid is a substance that is proved to activate blood flow in the brain, increase the quantity of oxygen supplied, promote metabolism in the brain cell, achieve symptomatic improvement in the case of headache observed as an aftereffect of, for example, cerebral stroke, or lower the blood pressure by acting upon the vasomotor center in the bulbar.

The isoflavone of the present invention is one or more types of isoflavone selected from daidzin, daidzein, genistin, genistein, glycitin, gulycitein, acetyldaidzin, acetylgenistin, acetylglycitin, malonyldaidzin, malonylgenistin, and malonylglycitin. It is generally known that these isoflavones have preventive effects against osteoporosis, menopause, etc.; however, due to their bitterness, they are not preferable components in point of a flavor.

For improved flavor, the balance of taste and bitterness of beans is controlled in such a way that the mass ratio of gamma-aminobutyric acid to isoflavone in the germinated beans of the present invention is adjusted preferably to 10/100 to 250/100, more preferably to 15/100 to 200/100, and most preferably to 20/100 to 150/100. When the mass ratio of gamma-aminobutyric acid to isoflavone is less than 10/100, the beans have more bitterness and astringency, while when the mass ratio of gamma-aminobutyric acid to isoflavone is greater than 250/100, the gamma-aminobutyric acid tastes too strong, breaking the balance of the overall taste.

The germination of beans adjusts the mass ratio of gamma-aminobutyric acid to isoflavone. The mass ratio of gamma-aminobutyric acid to isoflavone can be calculated by the equation:
Mass ratio of gamma-aminobutyric acid to isoflavone=Content (mg) of gamma-aminobutyric acid in 100 g of beans/Content (mg) of isoflavone in 100 g of beans

In order to determine the content (mg) of gamma-aminobutyric acid in 100 g of beans used in the above equation, 1 to 10 g of beans are ground and then poured into a polar solvent such as methanol, ethanol, water-containing methanol, and water-containing ethanol, then homogenized and heated to approximately 80 degrees Celsius as necessary. The resultant liquid is filtered, and the filtered liquid may be analyzed by an automatic amino acid analyzer. In other cases, the content (mg) of gamma-aminobutyric acid may be determined in such a way that, after 1 to 10 g of beans are ground, their protein is removed by using 10 W/V % of sulfosalicylic acid solution, is pH adjusted, and is filtered to obtain a liquid, and finally the liquid may be analyzed by an automatic amino acid analyzer. On the other hand, in order to determine the content (mg) of isoflavone in 100 g of beans, 1 to 10 mg as soybean isoflavone is ground and then poured into a polar solvent such as methanol, ethanol, water-containing methanol, and water-containing ethanol, then homogenized or heated to reflux as necessary. The resultant liquid is filtered and the filtered liquid may be analyzed by HPLC.

In order to adjust the content of gamma-aminobutyric acid of germinated beans and the mass ratio of gamma-aminobutyric acid to isoflavone of germinated beans in the present invention, the ratio of beans to shoots or roots germinated to a length of 0.5 to 20 mm among the total beans that have been under germination process and actually germinated is preferably 70% to 100%, more preferably 80% to 100%, and most preferably 90% to 100%. The ratio of beans with shoots or roots germinated to a length of 0.5 to 20 mm is preferably maintained within the above range because when the ratio of the beans with shoots or roots at a length of 0.5 mm or longer is increased, the astringency is almost eliminated, and when the ratio of the beans with shoots or roots at a length of 20 mm or shorter, good taste and sweetness remains, resulting in tasty germinated beans.

The ratio of total number of beans that has shoots or roots actually germinated to 0.5 to 20 mm in length calculated by the equation:
The ratio (%) of total number of beans that has shoots or roots actually germinated to 0.5 to 20 mm in length=The number of beans that have 0.5 to 20 mm in length of shoots or roots/number of beans actually germinated among 100 beans selected arbitrarily from beans under a germination process.

The length of emerged shoots or roots can be adjusted by controlling the exposure time of beans to air or oxygen after immersion of the beans into water or hot water. Specifically, the longer the exposure time of beans to air or oxygen, the longer the length of shoots or roots become. In the case in which air or oxygen is blown in during the immersion process of beans, the promotion of the germination can be controlled by the volume of blown-in air or oxygen. Specifically, the more air or oxygen blown in, the longer the length of shoots or roots becomes. In the case of soybeans, for example, the ratio of germination in which beans are hydrated appropriately at a temperature of 25 degrees Celsius for 24 hours after immersion is approximately 65% and 100% of beans have shoots with a length of 0.5 mm to 20 mm.

In order to increase the content of gamma-aminobutyric acid and improve the nutritive value, and furthermore, to hold a greater balance of taste and improve the flavor of beans, the germinated beans of the present invention contain gamma-aminobutyric acid per 100 g of solid content of beans preferably at 50 to 500 mg, more preferably at 75 to 500 mg, and most preferably at 100 to 500 mg.

The term “solid content of beans” used herein refers to a “solid content in which the mass of water in the beans is deducted from the gross mass of beans”, and the term “content of beans per 100 g in solid content” refers to a “content of solid content of beans per 100 g in which the mass of water in the beans is deducted from the gross mass of beans”. The mass of water in the beans can be determined, for example, by ambient pressure drying (at a temperature of 105 degrees Celsius for 5 hours). The term “the content of gamma-aminobutyric acid in 100 g of solid content of beans” therefore refers to “the content of gamma-aminobutyric acid in 100 g of solid content of beans in which the mass of water in the beans is deducted from gross mass of beans”.

The content (mg) of gamma-aminobutyric acid in 100 g of solid content of beans is calculated by the equation:
The content (mg) of gamma-aminobutyric acid in 100 g of solid content of beans=The content (mg) of gamma-aminobutyric acid in 100 g of beans/the ratio (percent by mass) of solid content of beans in the gross mass of beans×100

The content (mg) of gamma-aminobutyric acid in 100 g of beans can be determined as described above, and the ratio (percent by mass) of the solid content of beans in the gross mass of beans can be determined by the following equation. The mass (g) of water in the beans in the equation can be measured by ambient pressure drying (at 105 degrees Celsius for 5 hours).
The ratio (percent by mass) of solid content of beans in the gross mass of beans=(gross mass (g) of beans−mass (g) of water in the beans)/gross mass (g) of beans×100

In order to adjust the content of gamma-aminobutyric acid in 100 g of solid content of germinated beans within a range described above, the ratio of germination is preferably kept within a range of 10% to 100%, more preferably 20% to 100%, and most preferably 30% to 95%, and the germination is conducted in such a way that the ratio of number of beans having shoots or roots at a length of 0.5 to 20 mm is maintained within a range of preferably 70% to 100%, more preferably 80% to 100%, and most preferably 90% to 100% of the total beans that actually germinated.

The bean processed food of the present invention that contains the aforementioned germinated beans as a main ingredient is described as follows.

The ratio of germination under germination process that is used as a main ingredient of the bean processed food of the present invention is preferably 10% to 100%, more preferably 20% to 100%, and most preferably 30% to 95%, and the ratio of number of beans with shoots or roots at a length of 0.5 to 20 mm is preferably 70% to 100%, more preferably 80% to 100%, and most preferably 90% to 100% of the total beans that have been under germination process and actually germinated. The reason for the preferred ratio of germination, methods of adjusting and calculating the numerical value, types of the germinated beans, and methods for germination are identical to the germinated beans of the present invention described above.

When the ratio of germination of beans which is used as a main ingredient of the bean processed food is 10% or less, the content of gamma-aminobutyric acid per 100 g of solid content of beans is 50 mg or less. In this case, the mass ratio of gamma-aminobutyric acid to isoflavone in the beans cannot be maintained within a range of 10/100 to 250/100, and thus the beans and the resulting bean processed food will taste more astringent and bitter. It is preferable that the rate of germinated beans which is a main ingredient of the soybean processed food and that have shoots or roots to a length of 0.5 to 20 mm be maintained in a range shown above. This is because when more beans that have shoots or roots in a length of no less than 5 mm are used, astringency of the beans that is a main ingredient of the processed food, and as a result, astringency of the bean processed food will be almost eliminated. In addition, more beans that have shoots or roots in a length of no more than 20 mm are used, the good taste and sweetness that constitute main ingredients of the processed food will not be reduced but will provide a tasty bean processed food.

The mass ratio of gamma-aminobutyric acid to isoflavone in the germinated beans that are used as main ingredients of the bean processed foods of the present invention is preferably 10/100 to 250/100, more preferably 15/100 to 200/100, and most preferably 20/100 to 150/100. The content of gamma-aminobutyric acid per 100 g of solid content of beans is preferably 50 to 500 mg, more preferably 75 to 500 mg, and most preferably 100 to 500 mg. The reason for the above, and methods of adjusting and calculating the numerical value are identical to those of the germinated beans of the present invention described above.

When the mass ratio of gamma-aminobutyric acid to isoflavone of the germinated beans that are a main ingredient of the processed food is less than 10/100, the bean processed food will have astringency and bitterness, while when the ratio is greater than 250/100, more gamma-aminobutyric acid is tasted and breaks a balance of taste of the overall bean processed food. The content of gamma-aminobutyric acid per 100 g of solid content of germinated beans that are a main ingredient of the processed food is maintained within the range shown above in order to increase the content of gamma-aminobutyric acid and improve the nutritive value, and furthermore, to keep a greater balance of taste and improve the flavor of bean processed food.

The bean processed food in the present invention uses germinated beans as a main ingredient and includes soybean milk, bean curd, soybean curd pulp, fermented soybeans, fermented soybean paste, or boiled beans (for example, boiled soybeans). Among the above, soybean in a form of soybean milk, bean curd, soybean curd pulp, or boiled beans (for example, boiled soybeans) can improve the taste because there exists no process that should change the properties such as taste as in fermentation process, and the tastes of soybean directly influence the processed food. The bean processed food such as soybean milk, bean curd, soybean curd pulp, fermented soybeans, fermented soybean paste, boiled beans (for example, boiled soybeans) may be manufactured by known manufacturing methods, except that germinated beans are used as the main ingredient.

The following describes bean processed food of the present invention that specifies mass ratio of gamma-aminobutyric acid to isoflavone, and content of gamma-aminobutyric acid.

The type of beans used for a main ingredient of a bean processed food of the present invention is not limited to, but includes soybean, green soybeans, kidney bean, adzuki bean, peanut, broad beans, pea, black bean, etc. Among these, soybean is most preferable in terms of nutritive value, processing suitability, and availability.

In order to improve the flavor, the balance of taste and bitterness of bean processed food is controlled in such a way that the mass ratio of gamma-aminobutyric acid to isoflavone in the bean processed food is adjusted preferably to 10/100 to 250/100, more preferably to 15/100 to 200/100, and most preferably to 20/100 to 150/100. When the mass ratio of gamma-aminobutyric acid to isoflavone in the bean processed food is smaller than 10/100, the bean processed food have more bitterness and astringency, while the mass ratio of gamma-aminobutyric acid to isoflavone is larger than 250/100, the gamma-aminobutyric acid tastes too strong, breaking the balance of the overall taste of the bean processed food.

Beans used as main ingredient of the processed food are germinated so as to control the mass ratio of gamma-aminobutyric acid to isoflavone in the beans preferably at 10/100 to 250/100, more preferably at 15/100 to 200/100, and most preferably at 20/100 to 150/100. Such germinated beans include the germinated beans of the present invention described above. When the mass ratio of gamma-aminobutyric acid to isoflavone that is a main ingredient for processed food of germinated beans is less than 10/100, the beans have more bitterness and astringency, and bean processed food has more bitterness and astringency, while when the mass ratio of gamma-aminobutyric acid to isoflavone is greater than 250/100, the gamma-aminobutyric acid tastes too strong, breaking the balance of the overall taste of the bean processed food.

The mass ratio of gamma-aminobutyric acid to isoflavone in the bean processed food can be determined using the equation:
The mass ratio of gamma-aminobutyric acid to isoflavone in the bean processed food=The content (mg) of gamma-aminobutyric acid in 100 g of the bean processed food/the content (mg) of isoflavone in 100 g of the bean processed food

In order to determine the content (mg) of gamma-aminobutyric acid in 100 g of bean processed food used in the above equation, 1 to 10 g of bean processed food is ground and then poured into a polar solvent such as methanol, ethanol, water-containing methanol, and water-containing ethanol, then homogenized and heated to approximately 80 degrees Celsius as necessary. The resultant liquid is filtered and the filtered liquid may be analyzed by an automatic amino acid analyzer. Subsequently, the content (mg) of gamma-aminobutyric acid in 100 g of bean processed food may be determined in such a way that, after 1 to 10 g of bean processed food is ground, their protein is removed by using 10 W/V % of sulfosalicylic acid solution, the pH adjusted, and it is filtered to obtain a liquid, and finally the liquid may be analyzed by an automatic amino acid analyzer.

On the other hand, in order to determine the content (mg) of isoflavone in 100 g of bean processed food, bean processed food corresponding to 1 to 10 mg as soybean isoflavone is ground and then poured into a polar solvent such as methanol, ethanol, water-containing methanol, and water-containing ethanol, and then is homogenized or heated to reflux as necessary. The resultant liquid is filtered and the filtered liquid may be analyzed by HPLC.

In order to increase the content of gamma-aminobutyric acid and improve the nutritive value, and furthermore, to maintain a greater balance of taste and improve the flavor of bean processed food, the bean processed food of the present invention contains gamma-aminobutyric acid per 100 g of solid content of beans preferably by 50 to 500 mg, more preferably by 75 to 500 mg, and most preferably by 100 to 500 mg. Such germinated beans include the germinated beans of the present invention described above. When the content of gamma-aminobutyric acid per 100 g of solid content of germinated beans that is a main ingredient for processed food is maintained within a range shown above in order to increase the content of gamma-aminobutyric acid in the bean processed food and improve the nutritive value, and furthermore, to maintain a greater balance of taste and improve the flavor of bean processed food.

The term “solid content of bean processed food” used herein refers to a “solid content in which mass of water in bean processed food is deducted from the gross mass of bean processed food”, and the term “content of bean processed food per 100 g in solid content” refers to a “content of solid content of beans per 100 g in which the mass of water in the bean processed food is deducted from the gross mass of bean processed food”. The mass of water in the bean processed foods can be determined for example by ambient pressure drying (at a temperature of 105 degrees Celsius for 5 hours). The term “the content of gamma-aminobutyric acid in 100 g of solid content of bean processed food” therefore refers to “the content of gamma-aminobutyric acid in 100 g of solid content of bean processed food in which the mass of water in the bean processed food is deducted from the gross mass of bean processed food”.

The content (mg) of gamma-aminobutyric acid in 100 g of solid content of bean processed food is calculated by the equation:
The content (mg) of gamma-aminobutyric acid in 100 g of solid content of bean processed food=The content (mg) of gamma-aminobutyric acid in 100 g of bean processed food/the ratio (percent by mass) of solid content of bean processed food in the gross mass of bean processed food×100

The content (mg) of gamma-aminobutyric acid in 100 g of bean processed food can be determined as described above, and the ratio (percent by mass) of solid content of bean processed food in gross mass of bean processed food can be determined by the following equation. The mass of water in the bean processed food can be measured by ambient pressure drying (at a temperature of 105 degrees Celsius for 5 hours).
The ratio (percent by mass) of solid content of bean processed food in the gross mass of bean processed food=(gross mass (g) of bean processed food−mass (g) of water in the bean processed food)/gross mass (g) of bean processed food×100

The germination ratio is preferably set within a range of 10% to 100%, more preferably 20% to 100%, and most preferably 30% to 95%, and by conducting the germination, the ratio of number of beans having shoots or roots at a length of 0.5 to 20 mm is set within a range of preferably 70% to 100%, more preferably 80% to 100%, and most preferably 90% to 100% of total beans that are actually germinated, so that the content of gamma-aminobutyric acid in 100 g of solid content of bean processed food is controlled so as to be in the above-mentioned range. These germinated beans may include the germinated beans of the present invention as described above.

When the ratio of germination of germinated beans which is used as a main ingredient of the bean processed food is 10% or less, the content of gamma-aminobutyric acid per 100 g of solid content of beans will be 50 mg or less. In this case, the mass ratio of gamma-aminobutyric acid to isoflavone in the beans cannot be maintained within a range of 10/100 to 250/100, and thus the beans as a main ingredient of the bean processed food and the resulting bean processed food will taste more astringent and bitter.

It is preferable that the rate of germinated beans which is a main ingredient of the bean processed food and that have shoots or roots of a length of 0.5 to 20 mm be maintained within a range shown above. This is because when more beans that have shoots or roots in a length of no less than 5 mm are used, the beans that is a main ingredient of the bean processed food are not astringency, and as a result, bitterness of the bean processed food will be almost eliminated. In addition, more beans that have shoots or roots in a length of no more than 20 mm are used, the good taste and sweetness of the beans that constitutes the main ingredient of the processed food will not be reduced but will provide a tasty bean processed food.

The bean processed food of the present invention uses germinated beans as a main ingredient and includes soybean milk, bean curd, soybean curd pulp, fermented soybeans, fermented soybean paste, and boiled beans (for example, boiled soybeans). Among these, soybeans can improve the taste because there exists no process that should change the properties such as taste as in a fermentation process, and the taste of soybeans directly influences the processed food.

The bean processed food such as soybean milk, bean curd, soybean curd pulp, fermented soybeans, fermented soybean paste, boiled beans (for example, boiled soybeans) may be manufactured by known manufacturing methods except that germinated beans are used as main ingredient. In that case, however, in order to set the mass ratio of gamma-aminobutyric acid to isoflavone in the bean processed food and the content of gamma-aminobutyric acid per 100 g of solid content of bean processed food at a specified value, the mass ratio of gamma-aminobutyric acid to isoflavone in beans and the content of gamma-aminobutyric acid per 100 g of solid content of beans should be considered carefully as described above.

The germinated beans or bean processed food as described above may be used in foods that do not use beans as main ingredient for processed food, the food including breads, pizzas, noodles such as wheat noodles, buckwheat noodles, and fine noodles, dairy products such as ice creams, puddings, and yogurts, sweets such as cookies, biscuits, or Japanese sweets such as rice crackers, fried rice crackers, or cubic rice crackers. The mass ratio of gamma-aminobutyric acid to isoflavone in such foods is maintained constant within a range, and use of germinated beans gives neither astringency nor bitterness but yields a tasty and well balanced food.

The quantity of germinated beans of the present invention or the bean processed food applied to the above foods is not particularly limited. In addition, any foods that use germinated beans of the present invention or any foods that use the bean processed food may be added with germinated beans of the present invention or the soybean processed food as a main ingredient. The food itself may be manufactured by any known manufacturing method.

### EXAMPLE

Comparisons and examples are given to describe the present invention in detail. The present invention, however, shall not be limited to these examples. Evaluation method of the taste of boiled soybean, soybean milk, and bean curd

Evaluation was conducted on the taste of 10 g of boiled soybean, 30 ml of soybean milk; and 20 g of bean curd. Ten panelists tasted and scored each of them based upon the following criteria. Mean value of the evaluated points were calculated, and calculated points of not less than 4.0 were accepted.

1: Not satisfactory because of too much astringency and bitterness, or a part of taste components are too strong, making the taste out of balance.

2: Not satisfactory because of more or less astringency and bitterness, or a part of taste components are rather strong, making the taste out of balance.

3: Similar taste as ordinary beans.

4: Less astringency and bitterness and good balance of taste.

5. No astringency and bitterness and very good balance of taste.

### Comparative Example 1

### Boiled Soybeans

Preparation

300 g of non-germinated soybean (IOM, US) were immersed into 900 g of water at a temperature of 5 degrees Celsius for 18 hours. It was drained and the germination states were confirmed that no beans were germinated. The resultant 200 g of non-germinated soybeans were boiled for 30 minutes to obtain boiled soybeans.

Analysis and Taste Evaluation

The obtained 3 g of boiled soybeans were chopped using a Kokuyo cutter and dried at a temperature of 105 degrees Celsius for 5 hours. The mass of water in the boiled soybean was measured, and the ratio of solid content of boiled soybean in the gross mass of boiled soybean was calculated as 36 percent by mass.

3 g of boiled soybean was chopped by a cutter and stirred in solution of 10 W/V % sulfosalicylic acid. Then the pH was adjusted and it was filtered. The filtered liquid was analyzed by an automatic amino acid analyzer. The content of gamma-aminobutyric acid in 100 g of boiled soybean was 12.6 mg. From the measured value, the content of gamma-aminobutyric acid in 100 g of solid content of boiled soybean was calculated as 35.0 mg.

2 g of boiled soybean was chopped by a cutter and homogenized in a mass ratio of methanol:water=8:2. Heated and extracted under reflux twice an hour, and this was filtered. The filtered liquid was then HPLC analyzed. As a result of the analysis, the content of isoflavone in 100 g of the boiled soybean was 151.2 mg.

From these values, the mass ratio of gamma-aminobutyric acid to isoflavone in the boiled soybean was determined to be 8.3/100.

The obtained boiled soybean was evaluated by a taste evaluation method described above. Table 1 shows the evaluation results.

### Example 1

### Boiled Soybean

Preparation

300 g of non-germinated soybean (IOM, US) were immersed into 900 g of water at a temperature of 10 degrees Celsius for 10 hours. It was covered with plastic wrap with holes to prevent it from drying at an environment of 20 degrees Celsius and left it for 36 hours. 690 g of germinated soybean was obtained, in which the ratio of germination was 20%, and 100% of the total soybeans that have been under germination and actually germinated had roots in a length of 0.5 mm to 20 mm. 200 g of the obtained germinated soybeans were boiled in boiling water for 30 minutes to yield boiled soybeans.

Analysis and Taste Evaluation

3 g of the boiled soybeans were chopped by a cutter and dried at a temperature of 105 degrees Celsius for 5 hours. The mass of water in the boiled soybean was measured, and the ratio of solid content of boiled soybean in the gross mass of boiled soybean was calculated as 40 percent by mass.

3 g of boiled soybean was chopped by a cutter and stirred in a solution of 10 W/V % sulfosalicylic acid. Then, the pH was adjusted, and it was filtered. The filtered liquid was analyzed by an automatic amino acid analyzer. As a result of analysis, the content of gamma-aminobutyric acid in 100 g of boiled soybeans was 22.0 mg. From this analysis value, the content of gamma-aminobutyric acid in 100 g of solid content of boiled soybean was calculated as 55.0 mg.

2 g of boiled soybean was chopped by a cutter and homogenized in mass ratio of methanol:water=8:2. Heated and extracted under reflux twice an hour, and filtered. The filtered liquid was then HPLC analyzed. As a result of the analysis, the content of isoflavone in 100 g of the boiled soybean was 152.0 mg. From these values, the mass ratio of gamma-aminobutyric acid to isoflavone in boiled soybean was calculated as 14.5/100.

The obtained boiled soybean was evaluated by a taste evaluation method described above. Table 1 shows the evaluation results.

### Example 2

### Soybean Milk

Preparation

300 g of non-germinated soybean (IOM, US) were immersed into 900 g of water at a temperature of 25 degrees Celsius and at the same time 1500 ml of air per minute was blown over the soybeans for 30 hours. 690 g of germinated soybean was obtained, in which the ratio of germination was 30%, and 99% of the total soybeans that have been subjected to the germination process and actually germinated had roots in a length of 0.5 mm to 20 mm. One liter of water was added to 460 g of the obtained germinated soybeans and crushed. The produced soybean curd pulp was separated, then heated at a temperature of 90 degrees Celsius for 5 minutes, and cooled to yield soybean milk.

Analysis and Taste Evaluation

3 g of the obtained soybean milk was dried at a temperature of 105 degrees Celsius for 5 hours. The mass of water in the soybean milk was measured, and the ratio of solid content of soybean milk in the gross mass of soybean milk was calculated as 12 percent by mass.

3 g of soybean milk was stirred in a solution of 10 W/V % sulfosalicylic acid. Then, the pH was adjusted and filtered. The filtered liquid was analyzed by an automatic amino acid analyzer. As a result of the analysis, the content of gamma-aminobutyric acid in 100 g of soybean milk was 22.7 mg. From the analysis value, the content of gamma-aminobutyric acid in 100 g of solid content of soybean milk was calculated as 189.0 mg.

2 g of soybean milk was homogenized in mass ratio of methanol:water=8:2. Heated and extracted under reflux twice an hour, and filtered. The filtered liquid was then HPLC analyzed. As a result of the analysis, the content of isoflavone in 100 g of the soybean milk was 42.0 mg. From these values, the mass ratio of gamma-aminobutyric acid to isoflavone in the soybean milk was 54/100.

The obtained soybean milk was evaluated by a taste evaluation method described above. Table 1 shows the evaluation results.

### Example 3

### Soybean Milk

Preparation

30 kg of non-germinated soybean (IOM, US) was immersed into 100 L of hot water at a temperature of 40 degrees Celsius for 2 hours. 25 degrees Celsius of water was sprayed every 6 hours for 24 hours to promote germination. 69 kg of germinated soybeans was obtained, in which the ratio of germination was 80%, and 89% of the total soybeans that have been subjected to the germination process and actually germinated had roots of a length of 0.5 mm to 20 mm. The obtained 60 kg of germinated soybeans was added to water and crushed. Soybean curd pulp was produced and separated. The separated liquid was heated at a temperature of 145 degrees Celsius for 5 seconds by an instantaneous heater that directly blows steam, and was cooled to a temperature of 5 degrees Celsius. Table 2 shows an analysis value of composition of the obtained soybean milk.

Analysis and Taste Evaluation

3 g of soybean milk was dried at a temperature of 105 degrees Celsius for 5 hours. The mass of water in the soybean milk was measured, and the ratio of solid content of soybean milk in the gross mass of soybean milk was calculated as 12 percent by mass. 3 g of soybean milk was stirred in a solution of 10 W/V % sulfosalicylic acid. Then, the pH was adjusted and it was filtered. The filtered liquid was analyzed by an automatic amino acid analyzer. As a result of analysis, the content of gamma-aminobutyric acid in 100 g of soybean milk was 30.0 mg. From the analysis value, the content of gamma-aminobutyric acid in 100 g of solid content of soybean milk was calculated as 250.0 mg.

2 g of soybean milk was homogenized in a mass ratio of methanol:water=8:2. Heated and extracted under reflux twice an hour, and it was filtered. The filtered liquid was then HPLC analyzed. As a result of the analysis, the content of isoflavone in 100 g of the soybean milk was 48.4 mg. From these values, the mass ratio of gamma-aminobutyric acid to isoflavone in soybean milk was calculated as 62/100.

The obtained soybean milk was evaluated by a taste evaluation method described above. Table 1 shows the evaluation results.

### Example 4

### Bean Curd

Preparation

Into 300 g of soybean milk obtained in Example 3, 1.2 g of glucono delta lactone was added, then heated to a temperature of 80 degrees Celsius and cooled to a temperature of 5 degrees Celsius to obtain bean curd.

Analysis and Taste Evaluation

The 3 g of the obtained bean curd was dried at a temperature of 105 degrees Celsius for 5 hours. The mass of water in the bean curd was measured, and the ratio of solid content of bean curd in the gross mass of bean curd was calculated as 12 percent by mass.

3 g of bean curd was stirred in a solution of 10 W/V % sulfosalicylic acid. Then pH adjusted and filtered. The filtered liquid was analyzed by an automatic amino acid analyzer. As a result of analysis, the content of gamma-aminobutyric acid in 100 g of bean curd was 29.8 mg. From the analysis value, the content of gamma-aminobutyric acid in 100 g of solid content of bean curd was calculated as 248.3 mg.

2 g of bean curd was homogenized in mass ratio of methanol:water=8:2. Heated and extracted under reflux twice an hour, and this was filtered. The filtered liquid was then HPLC analyzed. As a result of the analysis, the content of isoflavone in 100 g of the bean curd was 48.2 mg.

From these values, the mass ratio of gamma-aminobutyric acid to isoflavone in bean curd was calculated as 62/100.

The obtained bean curd was evaluated by a taste evaluation method described above. Table 1 shows the evaluation results.

TABLE 1

| | Gamma- | | |
|---|---|---|---|
| | aminobutyric | Mass ratio of | |
| | acid (mg/100 g | Gamma- | Result of |
| | of solid | aminobutyric/ | taste |
| | content) | isoflavone | evaluation |
| Comparative | 35.0 | 8.3/100 | 3.1 |
| Example 1 | | | |
| Example 1 | 55.0 | 14.5/100 | 4.0 |
| Example 2 | 189.0 | 54/100 | 4.3 |
| Example 3 | 250.0 | 62/100 | 4.5 |
| Example 4 | 248.3 | 61.8/100 | 4.9 |

TABLE 2

| | Analysis value of | |
|---|---|---|
| | composition (percent by | |
| | mass) | Method of analysis |
| Water | 88.0 | Ambient pressure |
| | | drying Method |
| Protein | 6.0 | Kjeldahl Method |
| Fat | 4.0 | Extraction of |
| | | mixed liquid of |
| | | chloroform and |
| | | methanol |
| Ash | 0.7 | Direct ashing |
| | | Method |
| Carbohydrate | 1.3 | Calculated from |
| | | other analysis |
| | | values of |
| | | composition |

1. Germinated beans with mass ratio of gamma-aminobutyric acid to isoflavone in said beans of 10/100 to 250/100.

2. The germinated beans according to claim 1, wherein the content of gamma-aminobutyric acid per 100 g of solid content of beans is 50 to 500 mg.

3. The germinated beans according to claim 1, wherein germination ratio of 10 to 100% and ratio of the beans with shoots or roots germinated to a length of 0.5 to 20 mm constitutes 70 to 100% of the total beans that have been subjected to the germination process and actually germinated.

4. The germinated beans according to claim 1, wherein said germinated beans are one or more types of beans selected from soybeans, green soybeans, kidney beans, adzuki beans, peanuts, broad beans, peas, and black beans.

5. A bean processed food comprising as a main ingredient the germinated beans according to claim 1.

6. The bean processed food according to claim 5, wherein the mass ratio of gamma-aminobutyric acid to isoflavone in the bean processed food is 10/100 to 250/100.

7. The bean processed food according to claim 5, wherein the content of gamma-aminobutyric acid per 100 g of solid content of the bean processed food is 50 to 500 mg.

8. The bean processed food according to claim 5, wherein said bean processed food is a type selected from soybean milk, bean curd, soybean curd pulp, fermented soybean paste, fermented soybeans, or boiled beans.

9. A food using germinated beans according to claim 1.

10. A food using bean processed food according to claim 5.

11. A manufacturing method for germinated beans comprising steps of:
immersing beans into water or hot water at a temperature of 10 to 45 degrees Celsius for 0.5 to 36 hours; and
making the beans contact with air or oxygen for 19 to 36 hours during or after the immersion of beans.

12. The manufacturing method for germinated beans according to claim 11, wherein said air-contacting process is conducted during said immersion process, and the air-contacting process blows said air or oxygen into said water or hot water.

13. The manufacturing method for germinated beans according to claim 11, wherein said air-contacting process is conducted after said immersion process, the process further comprises immersing of the beans into water or hot water or spraying the water or hot water at a predetermined interval.

14. The manufacturing method for geminated beans according to claim 11, wherein the ratio of beans with shoots or roots germinated to a length of 0.5 to 20 mm is controlled to constitute 70 to 100% of the total beans that have been subjected to the germination process and actually germinated.

15. The manufacturing method of germinated beans according to claim 11, wherein said beans are one or more types of beans selected from soybeans, green soybeans, kidney beans, adzuki beans, peanuts, broad beans, peas, and black beans.

16. A soybean milk using germinated soy bean, wherein the mass ratio of gamma-aminobutyric acid to isoflavone in the soybean milk is 10/100 to 250/100.

17. The soybean milk according to claim 16, wherein the content of gamma-aminobutyric acid per 100 g of solid content in said soybean milk is 50 to 500 mg.
